(19) United States
(12) Patent Application Publication
(10) Pub. No.: US 2024/0202882 A1
(43) Pub. Date: Jun. 20, 2024

(54) SYSTEMS AND METHODS FOR ADAPTIVE PROBING OF PIECEWISE CONTINUOUS SURFACES

(71) Applicant: FLORIDA STATE UNIVERSITY RESEARCH FOUNDATION, INC., Tallahassee, FL (US)

(72) Inventor: Chiwoo Park, Tallahassee, FL (US)

(21) Appl. No.: 18/532,296

(22) Filed: Dec. 7, 2023

Related U.S. Application Data
(60) Provisional application No. 63/386,823, filed on Dec. 9, 2022.

(51) Int. Cl. G06T 5/60; G06F 17/17

(52) U.S. Cl. CPC G06T 5/60; G06F 17/17; G06T 2207/20084

(57) ABSTRACT

Systems and methods are provided for image reconstruction of a sample via adaptive probing of piecewise continuous surfaces. A machine learning algorithm can be employed with scanning-based measurement instruments or experimental probers to optimize the selection of probe locations for effectively scanning piecewise continuous surfaces. A limited number of initial probes may first be obtained to estimate the piecewise continuous surface. The machine learning algorithm may then be leveraged to identify any subsequent probe locations used to obtain additional data points about the piecewise continuous surface. The selection of the probe locations may be performed iteratively until sufficient data has been obtained to generate an accurate image reconstruction.

### CROSS-REFERENCE TO RELATED APPLICATION

This application claims the benefit of U.S. Provisional Application Serial No. 63/386,823, filed Dec. 9, 2022, the disclosure of which is hereby incorporated by reference in its entirety, including all figures, tables, and drawings.

### BACKGROUND

Imaging or scanning a sample is often generally performed by “probing” different points on the sample to obtain data about the sample. Based on these data points, the reconstructed image of the sample may be generated. Methods currently exist to select these probing locations. However, these methods are typically optimized for probing continuous surfaces instead of piecewise continuous surfaces. Consequentially, these existing methods are inefficient for probing piecewise continuous surfaces because they require a larger number of probe data points to be captured to produce an accurate image reconstruction. This requirement of additional probe data points results in additional probing time and a higher risk of damaging the sample due to increased exposure to the probes.

### BRIEF SUMMARY

Embodiments of the subject invention provide novel and advantageous systems and methods for image reconstruction via adaptive probing of piecewise continuous surfaces. A machine learning algorithm can be employed with scanning-based measurement instruments or experimental probers to optimize the selection of probe locations for effectively scanning piecewise continuous surfaces. A limited number of initial probes may first be obtained to estimate the piecewise continuous surface. The machine learning algorithm may then be leveraged to identify any subsequent probe locations used to obtain additional data points about the piecewise continuous surface. The selection of the probe locations may be performed iteratively until sufficient data has been obtained to generate an accurate image reconstruction.

In an embodiment, a system for reconstructing an image of a sample can comprise: a processor; and a machine-readable medium in operable communication with the processor and having instructions thereon that, when executed, perform the following steps: receiving first data corresponding to a plurality of probe points of the sample; generating a first estimate of a piecewise continuous surface based on the first data; and using a machine learning algorithm to perform adaptive probing on the piecewise continuous surface to obtain a reconstructed image of the sample. The using of the machine learning algorithm to perform adaptive probing on the piecewise continuous surface can comprise: i) identifying (e.g., by the machine learning algorithm), based on the first estimate of the piecewise continuous surface, an updated plurality of probe points of the sample; ii) receiving (e.g., by the machine learning algorithm) updated data corresponding to the updated plurality of probe points of the sample; iii) generating (e.g., by the machine learning algorithm) an updated estimate of the piecewise continuous surface based on the updated data; iv) identifying (e.g., by the machine learning algorithm), based on the updated estimate of the piecewise continuous surface, an updated plurality of probe points of the sample; and v) repeating substeps ii)-iv) at least once. Substep v) can comprise iteratively repeating substeps ii)-iv) until the updated data is sufficient data to generate an accurate reconstructed image (this sufficiency can be determined by, for example, the machine learning algorithm, or based on user input (e.g., reviewing the current iteration and deciding whether to continue) and/or a predetermined number of iterations of the algorithm). Substep v) can comprise iteratively repeating substeps ii)-iv) a predetermined number of times (e.g., at least twice, at least three times, at least four times, at least five times, at least six times, at least seven times, at least 10 times, at least 20 times, at least 30 times, at least 50 times, at least 100 times, or more). In substeps i) and iv), the updated plurality of probe points of the sample can be identified based on bias and variance. In substeps i) and iv), the updated plurality of probe points of the sample can be identified using a jump Gaussian process (JGP). The JGP can use mean square error (MSE) and/or mean square prediction error (MSPE). The instructions when executed can further perform the step of training the machine learning algorithm (e.g., before receiving the first data). The system can further comprise a display in operable communication with the processor and/or the machine readable medium. The instructions when executed can further perform the step of displaying the reconstructed image (and/or any intermediate image, updated data, and/or updated plurality of probe points) on the display.

In another embodiment, a method for reconstructing an image of a sample can comprise: receiving (e.g., by a processor) first data corresponding to a plurality of probe points of the sample; generating (e.g., by the processor) a first estimate of a piecewise continuous surface based on the first data; and using (e.g., by the processor) a machine learning algorithm to perform adaptive probing on the piecewise continuous surface to obtain a reconstructed image of the sample. The using of the machine learning algorithm to perform adaptive probing on the piecewise continuous surface can comprise: i) identifying (e.g., by the machine learning algorithm), based on the first estimate of the piecewise continuous surface, an updated plurality of probe points of the sample; ii) receiving (e.g., by the machine learning algorithm) updated data corresponding to the updated plurality of probe points of the sample; iii) generating (e.g., by the machine learning algorithm) an updated estimate of the piecewise continuous surface based on the updated data; iv) identifying (e.g., by the machine learning algorithm), based on the updated estimate of the piecewise continuous surface, an updated plurality of probe points of the sample; and v) repeating substeps ii)-iv) at least once. Substep v) can comprise iteratively repeating substeps ii)-iv) until the updated data is sufficient data to generate an accurate reconstructed image (this sufficiency can be determined by, for example, the machine learning algorithm, or based on user input (e.g., reviewing the current iteration and deciding whether to continue) and/or a predetermined number of iterations of the algorithm). Substep v) can comprise iteratively repeating substeps ii)-iv) a predetermined number of times (e.g., at least twice, at least three times, at least four times, at least five times, at least six times, at least seven times, at least 10 times, at least 20 times, at least 30 times, at least 50 times, at least 100 times, or more). In substeps i) and iv), the updated plurality of probe points of the sample can be identified based on bias and variance. In substeps i) and iv), the updated plurality of probe points of the sample can be identified using a JGP. The JGP can use MSE and/or MSPE. The method can further comprise training (e.g., by the processor) the machine learning algorithm (e.g., before receiving the first data). The method can further comprise displaying (e.g., by the processor) the reconstructed image (and/or any intermediate image, updated data, and/or updated plurality of probe points) on a display (e.g., a display in operable communication with the processor).

### BRIEF DESCRIPTION OF THE DRAWINGS

FIG. 1 illustrates an example sparse or compressive imaging process, according to an embodiment of the subject invention.

FIG. 2 illustrates example sparse or compressive imaging, according to an embodiment of the subject invention.

FIG. 3 illustrates example partitioned regression approaches, according to an embodiment of the subject invention.

FIG. 4 illustrates example image reconstructions based on the example partitioned regression approaches, according to an embodiment of the subject invention.

FIG. 5A illustrates an example local nonparametric estimation, according to an embodiment of the subject invention.

FIG. 5B illustrates another example local nonparametric estimation, according to an embodiment of the subject invention.

FIG. 6 illustrates an example involving linear boundaries, according to an embodiment of the subject invention.

FIG. 7 illustrates an example involving quadratic boundaries, according to an embodiment of the subject invention.

FIG. 8 illustrates an example involving quadratic boundaries, according to an embodiment of the subject invention.

FIG. 9 illustrates a comparison between image construction performed using a jump Gaussian process (JGP) and conventional methods, according to an embodiment of the subject invention.

FIG. 10 illustrates a comparison between probe locations selected using the JGP approach described herein and probe locations selected using a conventional approach, according to an embodiment of the subject invention.

FIG. 11 is a plot depicting an estimation error based on probe location selection, according to an embodiment of the subject invention.

FIG. 12 illustrates an empirical distribution of \hat{p}ᵢ for a test function, according to an embodiment of the subject invention.

FIG. 13 illustrates bias and variances of JGP, according to an embodiment of the subject invention.

FIG. 14 illustrates three acquisitions functions, according to an embodiment of the subject invention.

FIG. 15 illustrates active selection of design points for three acquisition functions, according to an embodiment of the subject invention.

FIG. 16 illustrates an example of a computing system, according to an embodiment of the subject invention.

### DETAILED DESCRIPTION

Embodiments of the subject invention provide novel and advantageous systems and methods for image reconstruction of a sample via adaptive probing of piecewise continuous surfaces. A machine learning algorithm can be employed with scanning-based measurement instruments or experimental probers to optimize the selection of probe locations for effectively scanning piecewise continuous surfaces. A limited number of initial probes may first be obtained to estimate the piecewise continuous surface. The machine learning algorithm may then be leveraged to identify any subsequent probe locations used to obtain additional data points about the piecewise continuous surface. The selection of the probe locations may be performed iteratively until sufficient data has been obtained to generate an accurate image reconstruction (this sufficiency can be determined by, for example, the machine learning algorithm, or based on user input and/or a predetermined number of iterations of the algorithm).

This method for probe location selection is advantageous over existing methods because it allows for probing piecewise continuous surfaces, whereas existing algorithms may only be applicable to probing continuous surfaces. Probing of piecewise continuous surfaces finds many commercial applications in microscopy, instrumentation, and autonomous systems, for example (this is not intended to be limiting). One currently promising application is usage in electron microscopes (while reference is made herein to microscopes, these systems and methods may also be applicable to any other scanning-based instruments as well) to make effective uses of electron doses for scanning nanomaterials. Another promising application is as an algorithmic experimental planner in an autonomous system for scientific discovery, to algorithmically optimize experimental probes (or designs) for scientific and engineering experiments.

In one or more embodiments, the methods described herein may involve the use of a jump Gaussian process (JGP) model as surrogates for piecewise continuous response surfaces, which may be continuous within the same regimes of a design space but discontinuous across the regimes. Estimates of the bias and variance may be developed for the JGP model. The model bias may be largely influenced by the accuracy of classifying training data by governing regimes of surrogates, and the model variance may be comparable to that of the standard GP model (e.g., spacing of training data largely contributes to the variance). This suggests that, in order to reduce the model bias and variance together, more data points may be obtained around the boundaries between regimes while placing data points around less populated areas of a design space. Based on this principle and bias and/or variance estimates of Jump GP, three active learning criteria may be introduced: one minimizing the integrated mean square prediction error (IMSPE criterion), another placing at the peak of the mean square prediction error (MSPE criterion), and the last one placing at the peak of the predictive variance (e.g., variance criterion).

The three criteria were evaluated using various simulation scenarios by tracking the changes in the mean square error (MSE) and the negative log posterior density (NLPD) metrics for each choice of the criteria. The method described herein may involve the use of JGP with the MSPE criterion, however, this is not intended to be limiting.

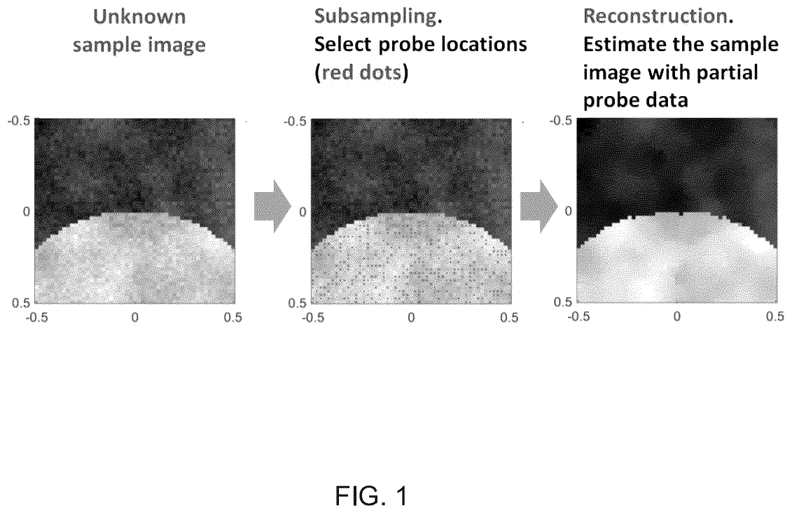

Turning to the figures, FIG. 1 illustrates an example sparse or compressive imaging process, according to one or more embodiments of the subject invention.

The sparse or compressive imaging process generally involves receiving an unknown sample image (shown on the left in FIG. 1), selecting probe locations to obtain data about the unknown sample image (shown in the middle in FIG. 1), and reconstructing the sample image using the probe data (shown on the right in FIG. 1).

Let [symbol] represent an image scape (2D grid of coordinate locations. Let f (x) represent an unknown sample image with f (x) as an unknown image intensity at an image location x∈ [symbol] . Reconstruction may be a regression problem for estimating unknown f, given (noisy) partial probe data given by:

[symbol]

={(xᵢ, yᵢ), yᵢ=f(xᵢ)+∈ᵢ, i=1, . . . , N}.

Say the estimate is given by \hat{f}(x; [symbol] ).

Subsampling is an active machine learning problem: how to optimize the probe locations {xᵢ, i=1, . . . , N} for minimizing the reconstruction error given by:

Err [symbol] = [symbol] [symbol] _{y}[(f(x)−\hat{f}(x; [symbol] ))²dx].

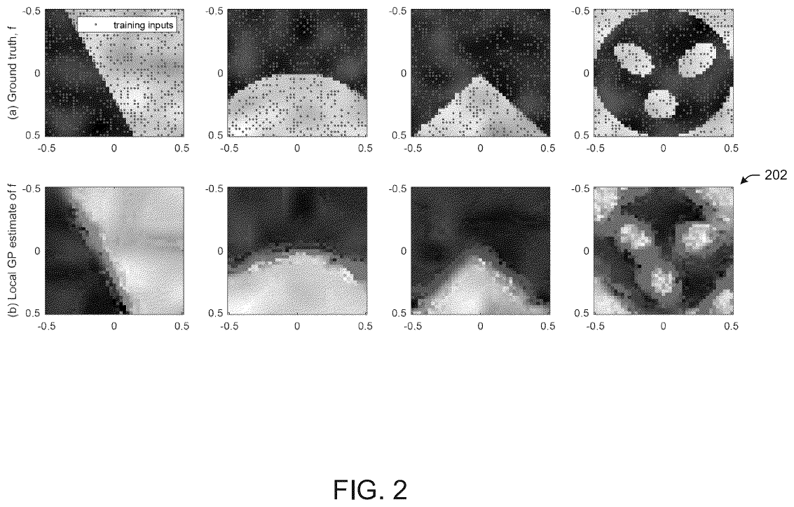

FIG. 2 illustrates example sparse or compressive imaging, according to one or more embodiments of the subject invention.

In most regression analysis, the underlying regression model f(x) may be assumed to be a smooth and continuous function. The assumption helps to average out image noises. However, image intensities may not be continuous. The top row of images shown in FIG. 2 illustrates sample images (images that are desired to be reconstructed) and selected probing locations for the sample images (shown as red dots on the sample images). The bottom row of images shows the reconstructed images based on the probe data obtained from the sample images in the first row. As shown in image reconstruction 202 on the right, conventional approaches for probe location selection may result in poor image reconstructions of the original sample image for piecewise continuous surfaces.

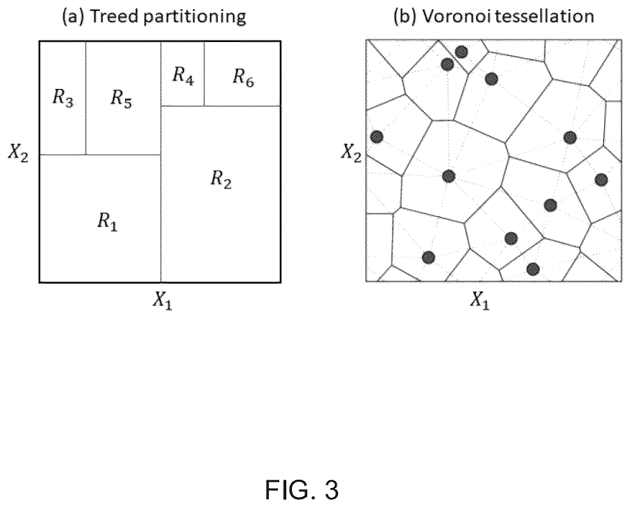

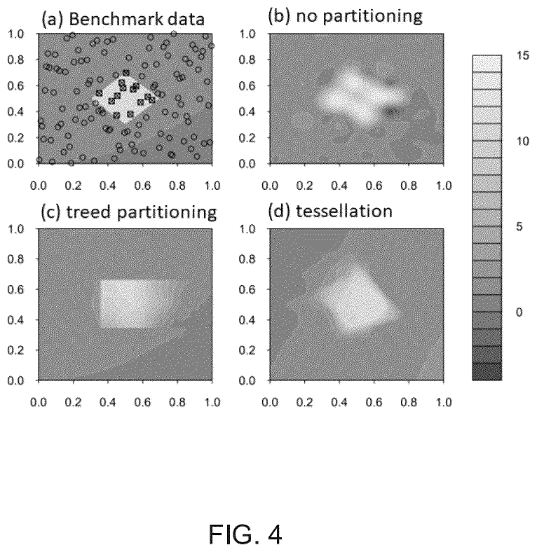

FIGS. 3 and 4 illustrate example partitioned regression approaches, in accordance with one or more embodiments of the subject invention.

Proper models for image intensity function f(x) may be a partitioned regression. Consider a partition of the image space [symbol] into subregions { [symbol] ₖ, k=1, . . . , K}. There may be an independent regression model for each region:

$$f ( x ) = {\sum }_{k = 1}^{K} {f}_{k} ( x ) {1}_{{ℛ}_{k}} ( x ) .$$

The fₖ(x) may be a continuous regression model for region [symbol] ₖ, parameterized by θₖ. Here, Gaussian process (GP) repressors may be used because this provides well-calibrated uncertainty quantification capability for active machine learning. The challenge here is that there may exist a large number of model parameters. The regional regression models {θₖ, k=1, K}, the space partition { [symbol] ₖ, k=1, . . . , K}, and even the number K may be unknown.

FIG. 3 illustrates two conventional approaches for selecting probe locations that involve the use of partitioned regression. A first approach, shown on the left, involves Treed partitioning and GP regression. A second approach, shown on the right, involves Voronoi tessellation and GP regression. FIG. 4 shows the resulting image reconstructions when using these conventional approaches. Image (a) in FIG. 4 shows the sample image and selected probe locations. Image (b) in FIG. 4 shows an image reconstruction that is performed without using any partitioned regression. Images (c) and (d) in FIG. 4 show image reconstructions when the Treed partitioning and Voronoi tessellation approaches illustrated in FIG. 3 are used to select probe locations. As shown in images (c) and (d), the Voronoi tessellation approaches do provide for a higher quality image reconstruction than image (b) from the Treed partitioning, but still do not effectively capture the original shape in the sample image shown in image (a).

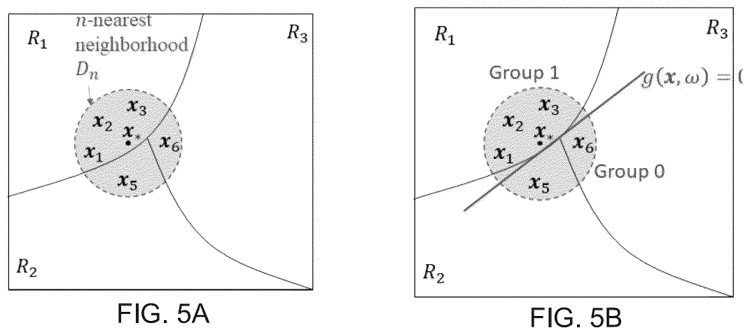

FIG. 5A illustrates an example local nonparametric estimation, according to one or more embodiments of the subject invention.

Particularly, FIG. 5A shows an example conventional local nonparametric estimation.

This conventional approach involves taking a small subset of probe data nearing a test location x_{*} (e.g., n-nearest neighbors).

[symbol]

ₙ={(x_{i,*}, y_{i,*}): i=1, . . . , n}.

The weighted average of the local data is determined to make a prediction for f (x_{*}). This is advantageous because for many test locations, the local data may be from one region. This may be more adaptive to local trends. However, this approach may still be insufficient because the local data may be mixed from different regions, when x_{*} is around border lines of different regions of the sample.

FIG. 5B illustrates another example local nonparametric estimation, according to one or more embodiments of the subject invention.

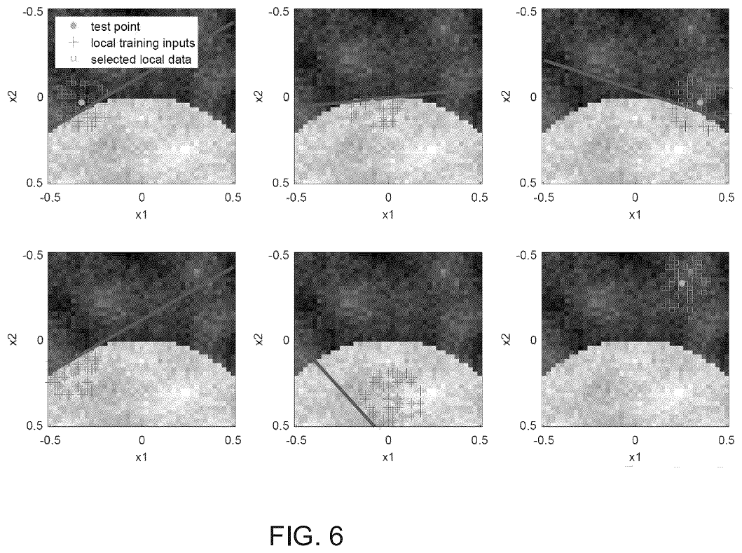

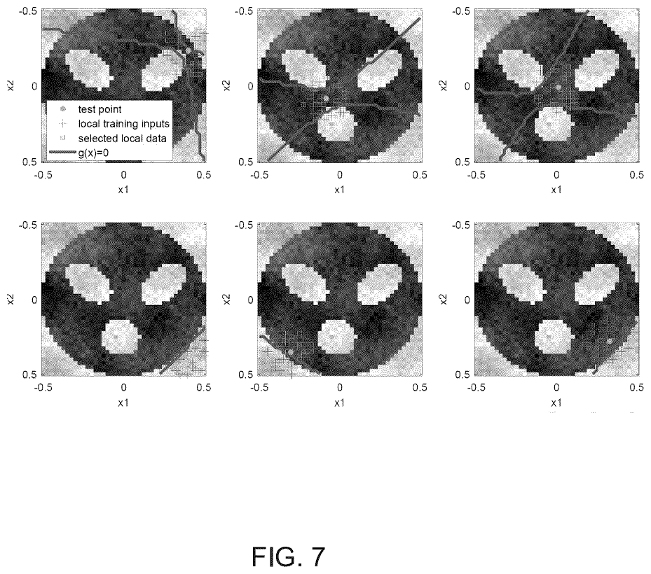

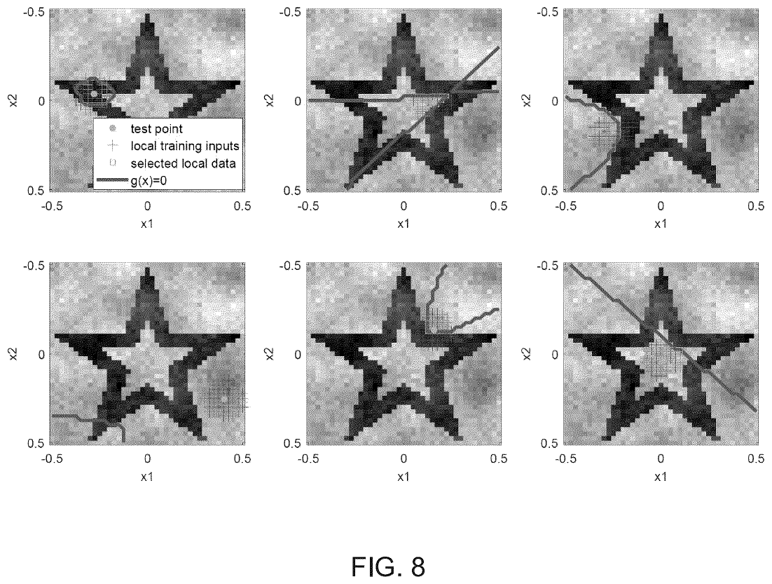

Particularly, FIG. 5B shows example local nonparametric estimation associated with the methods described herein. This approach may involve bisecting local data [symbol] ₙ(x_{*}) by a parametric curve g(x, w)=0 into two sides. In this example, Group 1 may be the same side as test point x_{*}. Group 0 may be the other side. The boundary g(x, w)=0 may be fine-tuned so as to have Group 1 include only data from the same region as the test point. Finally, a local regress or is fit to Group 1. This concept may be referred to as “jump GP” or “JGP” herein. For example, FIG. 6 shows an example in which linear boundaries are used and FIGS. 7-8 show examples where quadratic boundaries are used. Table 1 presented below provides some examples of distinguishing features between existing piecewise models and the “JGP” described herein.

TABLE 1

| Existing piecewise models | Jump GP model |
|---|---|
| parameters for K regional models | parameter for one local |
| {fₖ(x), k = 1, . . . , K} | model f(x) |
| needs to estimate K | no need to know K |
| global noise parameter σ² | local noise parameter σ² |
| need to estimate complex global | simple local bisection |
| partitioning { [symbol] ₖ, k = 1, . . . , K} | g(x, w) = 0 |
| Complex Bayesian model | simple bimixture model |
| expensive MCMC calculations | expectation-maximization |
| | (EM) algorithm |

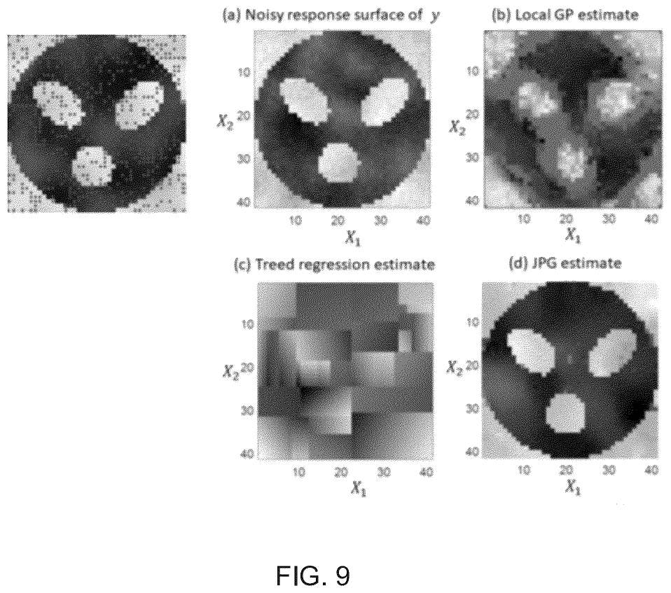

FIG. 9 illustrates a comparison between image construction performed using JGP and conventional methods, according to one or more embodiments of the subject invention.

Image (b) of FIG. 9 shows an image reconstruction based on a local GP estimate. Image (c) shows an image reconstruction based on the Treed regression estimate shown in FIG. 3. Finally, image (d) shows an image reconstruction based on the JGP estimate described herein. As shown in FIG. 9, the image reconstruction performed using the JGP estimate better resembles the original sample image shown on the left with the example probe locations.

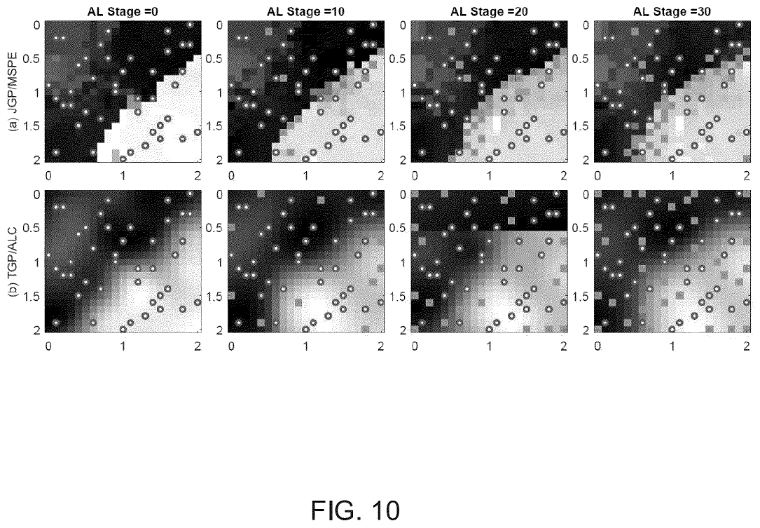

FIG. 10 illustrates a comparison between probe locations selected using the JGP approach described herein and probe locations selected using a conventional approach, according to one or more embodiments of the subject invention.

As shown in FIG. 9, the use of JGP alone provides more accurate image reconstruction for given data [symbol] . However, in many cases, the data acquisition process may be controlled in order to elect [symbol] for achieving specific machine goals, such as scanning coil control in Scanning Transmission Electron Microscope (STEM), for example. Thus, active learning (AL) (or sequential design of experiments) may also be used in associated with the JGP to further optimize the probe locations in compressive imaging.

AL attempts to make a virtuous cycle between data collection and model learning. AL may involve beginning with a small seed data [symbol] _{N}={(xᵢ, yᵢ), i=1, . . . , N} from a space filling design. The data [symbol] _{N} may be augmented with a new data point (e.g., a new probe location) (x_{N+1}, Y_{N+1}) and repeating this process to add additional probe locations. One approach to placing X_{N+1} is the maximum error criterion:

$${x}_{N + 1} = {arg max}_{{x}_{*} ∈ χ} Err [ \hat{f} ( {x}_{*} ; {𝒟}_{𝒩} ) ]$$

The error criterion may include of two parts: the model bias and variance. The bias may be the average discrepancy of the model prediction \hat{f}(x_{*}; [symbol] _{N}) from the true response f (x_{*}). The variance may be the variance of the model prediction \hat{f}(x_{*}; [symbol] _{N}), depending on the choice of data [symbol] _{N}. All existing AL criteria consider only the variance, assuming no bias. This draws an ineffective choice of the probe locations. The method described herein instead takes both the bias and the variance into account to optimize the probe locations.

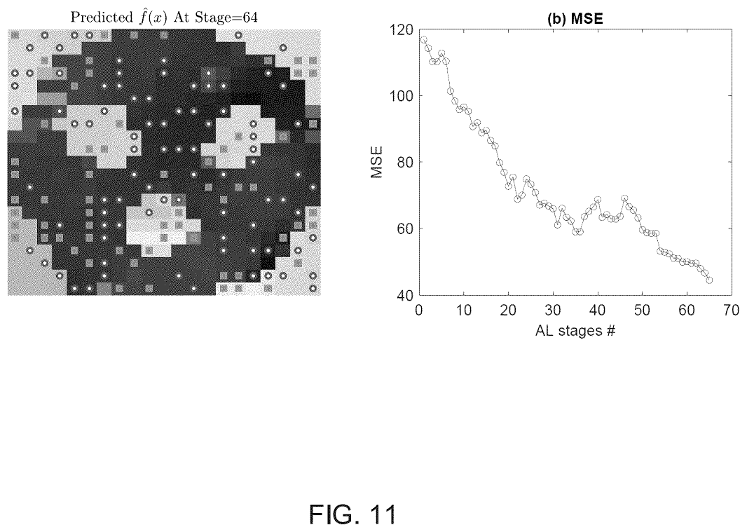

FIG. 11 is a plot depicting an estimation error based on probe location selection, according to one or more embodiments of the subject invention.

On the left is shown a same image with indications of selected probe locations. The red dots indicate initiate probe locations and the green boxes indicate probe locations actively selected by the JGP described herein. The plot on the right shows mean squared estimation error as a function of the number of AL stages. The plot shows that the mean squared error drops significantly as the number of AL stages increases.

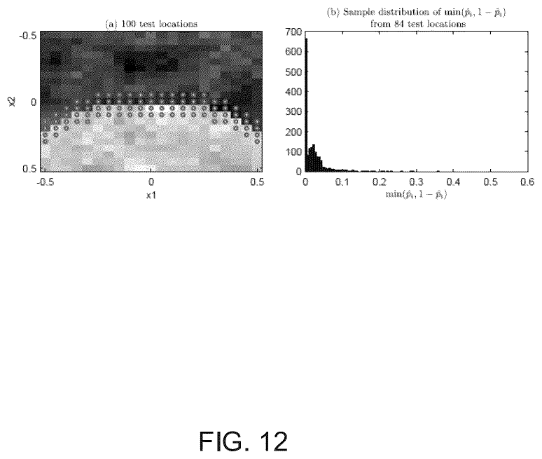

FIGS. 12-16 provide additional implementation details about conventional methods, the improved methods described herein, and the distinguishing factors between the two approaches.

AL of Gaussian process (GP) surrogates is useful for optimizing experimental designs for physical and/or computer simulation experiments, and for steering data acquisition schemes in machine learning. Described herein is a method for active learning of piecewise, JGP surrogates. JGPs may be continuous within, but discontinuous across, regions of a design space, as required for applications spanning autonomous materials design and configuration of smart factory systems. AL schemes may additionally account for model bias, as opposed to the usual model uncertainty, which may be useful in the JGP context. Toward that end, an estimator may be used for bias and variance of JGP models.

One goal of machine learning in general is to create an autonomous computer system that may learn from data with minimal human intervention. In many machine learning tasks, the data acquisition process may be controlled in order to select training examples that target specific goals. AL, or sequential design of experiments, is the study of how to select data toward optimizing a given learning objective. AL for piecewise continuous GP regression models may be described herein.

A motivating application is surrogate modeling of modern engineering systems, to explore and understand overall system performance and ultimately to optimize aspects of their design. A particular focus here is on engineering systems whose behaviors intermittently exhibit abrupt jumps or local discontinuities across regimes of a design space. Such “jump system” behaviors are found in many applications. For example, carbon nanotube yield from a chemical vapor deposition (CVD) process may vary depending on many design variables. Changes in dynamics may be gradual, but process yield can suddenly jump, depending on chemical equilibrium conditions, from ‘no-growth’ to ‘growth’ regions. Specific boundary conditions dictating these regime shifts may depend on experimental and system design details. Such jump system behaviors may be universal to many material and chemistry applications owing to many factors (i.e., equilibrium, phase changes, activation energy). Jump behaviors are also frequently seen in engineering systems operating near capacity. When a system runs below its capacity, performance is generally sufficient and exhibits little fluctuation. However, performance may suddenly break down as the system is forced to run slightly over its capacity.

Suitable surrogate models for jump systems may accommodate piece-wise continuous functional relationships, where disparate input-output dynamics can be learned (if data from the process exemplify them) in geographically distinct regions on input/configuration space. Most existing surrogate modeling schemes make an assumption of stationarity, and thus may not be well-suited to such processes. AL strategies paired with such surrogates are, consequently, sub-optimal for acquiring training examples in such settings. For example, Gaussian processes may be a favorable choice for surrogate modeling of physical and computer. Gaussian processes are flexible, nonparametric, nonlinear, lend a degree of analytic tractability, and provide well-calibrated uncertainty quantification without having to tune many unknown quantities. However, the canonical, relative-distance-based kernels used with GPs result in stationary processes. Space-filling designs, and their sequential analogues, are inefficient when input-output dynamics change across regions of the input space. Intuitively, we need a higher density of training examples in harder-to-model regions, and near boundaries where regime dynamics change.

Regime-changing dynamics may be inherently non-stationary. Both position and relative distance information (in the input configuration space) is required for effective modeling. Conventional non-stationary GP modeling strategies exist, however, these approaches are often too slow, in many cases demanding enormous computational resources in their own right, or limited to two input dimensions.

In contrast, deep GPs may provide a more effectively alternative. Input dimensions may be larger, and fast inference may be provided by doubly stochastic variational inference. However, such methods may be data-hungry, requiring tens of thousands of training examples before they are competitive with conventional GP methods. An ALC-type active learning criterion has been developed for deep GPs, making them less data-hungry, but computational expense for Markov chain Monte Carlo (MCMC) inference may still be a bottleneck.

A class of methods built around divide-and-conquer strategies may offer the best of both worlds (computational thrift with modeling fidelity) by simultaneously imposing statistical and computational independence. The best-known examples include treed GPs and Voronoi tessellation-based GPs (shown in FIG. 3). Partitioning facilitates non-stationarity almost trivially, by independently fitting different GPs in different parts of the input space. However, learning the partition may be challenging. Sequential design and/or AL criteria have been adapted to some of these divide-and-conquer surrogates. ALM and ALC, for example, have been adapted for treed GPs. However the axis-aligned nature of the treed GP is not flexible enough to handle the complex, nonlinear manifold of regime change exhibited of many real datasets, as illustrated below.

In contrast, JGP seeks a local approximation to an otherwise potentially complex domain-partitioning and GP-modeling scheme. Crucially, direct inference for the JGP enjoys the same degree of analytic tractability as an ordinary, stationary GP. However, the methods described herein extend conventional AL strategies to consider both model bias and variance. The addition of bias may be in a non-stationary modeling setting. In particular, ordinary stationary GP surrogates can exhibit substantial bias for test location nearby regime changes. The JGP may help mitigate this bias, but may not completely remove it. Consequently established AL strategies that don't incorporate estimates of bias are limited in their ability to improve the sequential learning of the JGP. The method described herein may estimate both bias and variance for JGPs and parlay these into novel AL strategies for nonstationary surrogate modeling.

With respect to stationary GP regression, X may denote a d-dimensional input configuration space. A problem of estimating an unknown function f: X→ [symbol] relating inputs x_{I}∈X to a noisy real-valued response variables y, lid [symbol] (f(xᵢ), σ²) though examples composed as training data, D_{N}={(xᵢ, yᵢ), i=1, . . . , N}. In GP regression, a finite collection f_{N}=(f₁, . . . , f_{N}) of f(xᵢ)=fᵢ values is modeled as a Multi-Variate Normal (MVN) random vector. A common specification may involve a constant, scalar mean μ, and N*N correlation matrix C_{N}:f_{N}˜ [symbol] ₙ(μ1_{N}, C_{N}).

Rather than treating all [symbol] (N²) values in C_{N} as “tunable parameters,” it is common to use a kernel c(xᵢ, xⱼ, θ) defining correlations in terms of a small number of hyperparameters, θ. Kernel families may be decreasing functions of the geographic “distance” between its arguments xᵢ and xⱼ. The method described herein, however, may be agnostic to these choices. An assumption of stationarity is common, whereby c(xᵢ, xⱼ, θ)≡c(xᵢ−xⱼ; θ), i.e., only relative displacement xᵢ−xⱼ between inputs, not their positions, matters for modeling.

Integrating out latent f_{N} values to obtain a distribution for y_{N} may be straightforward because both are Gaussian. This leads to the marginal likelihood y_{N}˜ [symbol] _{N}(μ1_{N}, C_{N}+σ² [symbol] _{N}) which may be used to learn hyperparameters. MLEs \hat{μ} and \hat{σ}² may have closed forms conditional on θ. In some instances, \hat{μ}=1_{N}^{T}(\hat{σ}²I_{N}+C_{N})⁻¹y_{N}/1_{N}^{T}(\hat{σ}²I_{N}+C_{N})⁻¹1ₙ. Estimates for θ may depend on the kernel and generally requires numerical methods.

Analytic tractability may extend to prediction. Basic MVN conditioning from a joint model of Y_{N} and an unknown testing output Y(x_{*}) gives that Y(x_{*})|y_{N} is univariate Gaussian. The distribution for the latent function value \hat{f}(x)≡f(x_{*})|y_{N} may be presented below. This distribution is also Gaussian, with:

mean: μ(x_{*})=\hat{μ}+c_{N}^{T}(σ²I_{N}+C_{N})⁻¹(y_{N}−\hat{μ}1_{N}), and

variance: s²(x_{*})=c(x_{*}, x_{*}; \hat{θ})−c_{N}^{T}(\hat{σ}² [symbol] _{N}+C_{N})⁻¹c_{N}, (1)

where c_{N}=[c(xᵢ, x_{*}; \hat{θ}): I=1, . . . , N] is a N*1 vector of the covariance values between the training data and the test data point. Evaluating these prediction equations, like evaluating the MVN likelihood for hyperparameter inference, may involve decompositing the N*N matrix C_{N}. Although there is a high degree of analytic tractability, there are still substantial numerical hurdles to application in large-data settings.

With respect to divide-and-conquer GP modeling, partitioned GP models, generally, and the Jump GP, specifically, may consider an “f” that is piecewise continuous.

$$f ( x ) = {\sum }_{k = 1}^{K} {f}_{k} ( x ) {1}_{{χ}_{k}} ( x ) . \qquad ( 2 )$$

where [symbol] ₁, [symbol] ₂, . . . , [symbol] ₖ are a partition of [symbol] . Above, 1 [symbol] _{ₖ}(x) is an indicator function that determines whether x belongs to region [symbol] ₖ, and each fₖ(x) is a continuous function that serves as the bases of regression model on region [symbol] ₖ. Although variations abound, in one or more embodiments, each functional piece fₖ(x) may be taken to be a stationary GP.

Typically, each fₖ is taken to independent conditional on the partitioning mechanism. This assumption is summarized below for easy referencing later.

Independence: fₖ is independent of fⱼ for j≠k. (3)

Consequently, all hyperparameters describing fₖ may be analogously indexed and may be treated independently, e.g., μₖ, σₖ², and θₖ. Generally speaking, the data within region [symbol] ₖ may be used to learn these hyperparameters, via the likelihood applied on the subset of data [symbol] _{N}, whose x-locations may reside in [symbol] ₖ. Although it is possible to allow novel kernels cₖ in each region, it is common to fix a particular form (i.e., a family) for use throughout. Only its hyperparameters θₖ vary across regions, as in c(.,.; θₖ). Predicting with \hat{f}(x_{*}), conditional on a partition and estimated hyperparameters, is simply a matter of following Equation 2 with “hats.” That is, with \hat{f}ₖ defined analogously to Equation 1, i.e., using only y-values exclusive to each region. In practice, the sum over indicators in Equation 2 may be bypassed and one simply identifies the [symbol] ₖ to which x_{*} belongs and uses the corresponding \hat{f}ₖ directly.

Popular, data-driven partitioning schemes leveraging local stationary GP models include Voronoi tessellation or recursive axis-aligned, tree-based partitioning. These “structures,” defining K, and within-partition hyperparameters (μₖ, θₖ, σ²) may be jointly learned, via posterior sampling (e.g., Markov Chain Monte Carlo sampling). In so doing, one is organically learning a degree of non-stationarity. Independent GPs, via disparate independently learned hyperparameters, facilitate a position-dependent correlation structure. Learning separate σₖ² in each region can also accommodate heteroskedasticy. Such divide-and-conquer can additionally bring computational gains, through smaller-N calculations within each region of the partition.

With respect to local GP modeling, although there are many example settings where such partition-based GP models excel, their rigid partitioning structures may be a mismatch to many important real-data settings. The Jump GP is motivated by such applications. The idea may be best introduced through the lens of local, approximate GP modeling. For each test location x_{*}, select a small subset of training data nearby x_{*}: [symbol] ₙ(x_{*}={(x_{i*}, y_{i*})}ᵢ₌₁ⁿ⊂ [symbol] ₙ. Then, use a conventional, stationary GP model [symbol] ₙ(x_{*}) via \hat{f}ₙ(x_{*}). This is fast, because [symbol] (n³) is much better than [symbol] (N³) when n<<N, and massively parallelizable over many x_{*}∈ [symbol] . It is has a nice divide-and-conquer structure, but it is not a partition model (2). Nearby [symbol] ₙ(x′_{*}) might have some, all, or no elements in common. In some cases, LAGP can furnish biased predictions because independence (3) may be violated: local data [symbol] ₙ(x′_{*}) might mix training examples from regions of the input space exhibiting disparate input-output dynamics.

A JGP differs from basic LAGP modeling by selecting local data subsets in such a way as a partition (2) is maintained and independence (3) is enforced, so that bias is reduced. Toward this end, the JGP may introduce a latent, binary random variable Zi∈{0, 1} to express uncertainties on whether a local data point x_{i,*} belongs to a region of the input exhibiting the same (stationary) input-output dynamics as the test location x_{*}, or not:

$${Z}_{i} = \{ \begin{matrix}1 & if {x}_{i , *} and {x}_{*} belong to the same region \\ 0 & otherwise .\end{matrix}$$

Conditional on Zᵢ values, i=1, . . . , N, the local data [symbol] ₙ may be partitioned into two groups: [symbol] _{*}={i=1, . . . , N: Zᵢ=1} and [symbol] ₒ={1, . . . , n}\ [symbol] _{*}, lying in regions of the input space containing x_{*} and not, respectively.

Complete the specification by modeling [symbol] _{*} with a stationary GP (for example, as described above), [symbol] ₒ with dummy likelihood p(y_{i,*}|Zᵢ=0)∝U for some constant, U, and assign a prior for the latent variable Zᵢ via a sigmoid x on an unknown partitioning function g(x, w),

p(Zᵢ=1|x_{i,*},ω)=π(g(x_{i,*},ω)),

where ω is another hyperparameter. Specifically, for Z=(Zᵢ,i=1, . . . , n), f_{*}=(f_{i,*},i=1, . . . , n) and Θ={w, m_{*}, θ_{*}, σ²}, the JGP model may be summarized as follows.

$$\begin{matrix}p ( {y}_{n} \vert {f}_{*} , Z , Θ ) = {\prod }_{i = 1}^{n} {{𝒩}_{i} ( {y}_{i , *} \vert \text{?} , {σ}^{2} )}^{{Z}_{\text{?}} {U}^{1 - {Z}_{\text{?}}}} , \\ p ( Z \vert w ) = {\prod }_{i = 1}^{n} π * {( g ( {x}_{i , *} , w ) )}^{{Z}_{\text{?}}} {( 1 - π ( g ( {x}_{i , *} , w ) ) )}^{1 - {Z}_{\text{?}}} , \\ p ( {f}_{*} \vert {m}_{\text{?}} {θ}_{*} ) = {𝒩}_{\text{?}} ( {f}_{*} \vert {m}_{\text{?}} {1}_{\text{?}} , {C}_{\text{?}} ) ,\end{matrix}$$

$$\text{?} \text{indicates text missing or illegible when filed}$$

where yₙ=(y_{i,*},i=1, . . . , n) and Cₙₙ=[cx_{i,*},x_{i,*}; θ_{*}:i, j=1, . . . , n] is a square matrix of the covariance values evaluated for all pairs of the local data [symbol] ₙ(x_{*}).

Conditional on Θ, prediction \hat{f}(x_{*}) follows Equation (1) using local data [symbol] ₙ(x_{*}). Inference for latent Z may proceed by expectation maximization. However, a difficulty arises because the joint posterior distribution of Z and f_{*} is not tractable, complicating the step. As a workaround, a classification EM variation which replaces the E-step with a pointwise maximum a posteriori (MAP) of \hat{Z}.

AL attempts to sustain a virtuous cycle between data collection and model learning. Begin with training data of size N, [symbol] _{N}={(xᵢ, yᵢ), i=1, . . . , N}, such as a space-filling Latin hypercube design. Then, [symbol] _{N} may be augmented with a new data point (x_{N+1}, y_{N+1}) chosen to optimize a criterion quantifying an important aspect or capability of the model, and this process may be repeated. Mean square prediction error (MSPE) may be used comprising of squared bias and variance.

Many machine learning algorithms are equipped with the proofs of unbiasedness of predictions under regularity conditions. When training and testing data jointly satisfy a stationarity assumption, the GP predictor (1) is unbiased, and so the MSPE is equal to s²(xₛ). Consequently, many AL leverage this quantity. For example, the active learning may maximize this quantity directly: X_{N+1}= [symbol] s(xₛ). In repeated application, this AL strategy can be shown to approximate a maximum entropy design.

An integrated mean squared prediction error (IMSPE) criterion considers how the MSPE of GP is affected, globally in the input space, after injecting new data at x_{N+1}. Let S_{N+1}²(x_{*}) denote the predictive variance (1) a test location x_{*}, when the training data [symbol] _{N} is augmented with one additional input location x_{N+1}:

s²(x_{*}; x_{N+1})=c(x_{*}, x_{*}; \hat{θ})−c_{N+1}^{T}(\hat{σ}²I_{N+1}+C_{N+1})⁻¹c_{N+1},

where c_{N+1}=[c(xᵢ, x_{*}; \hat{θ}): i=1, . . . , N+1], C_{N+1} analogousy via \hat{θ} [symbol] _{N}. Then,

IMPSE(x_{N+1})= [symbol] s(xₛ; x_{N+1})dx_{*},

which has a closed form, although in machine learning an quadrature-based version called may be used.

Such variance-only criteria makes sense when data satisfies the unbiasedness condition, i.e., under stationarity, which can be egregiously violated in many real-world settings. In Bayesian optimization contexts, acquisition criteria have been extended to account for this bias, but this may not exist for AL targeting overall accuracy. Thus, the method described herein involves bias and variance estimates for JGP and exploit in order to improve their AL performance.

Bias-variance decomposition for JGPs may also be performed, for example, using Equation (1) with [symbol] _{N}(x_{*}). For convenience, these are re-written here, explicitly in that JGP notation. Let \hat{Z}ᵢ represent the MAP estimate at convergence (of the CEM algorithm) and let [symbol] _{n,*}={i=1, . . . , n: \hat{Z}=1} denote the estimate of [symbol] _{*} with n_{*} being the number of training data pairs in the set. Conditional on \hat{Θ}, the posterior predictive distribution of \hat{f}_{*}(x) at a test location x_{*} is univariate Gaussian with

mean: μ_{J}(x_{*})=\hat{m}_{*}+c_{*}^{T}(σ²Iₙ_{_{*}}+C_{**})⁻¹(y_{*}−\hat{m}_{*}1ₙ_{_{*}}), and

variance: s_{J}²(x_{*})=c(x_{*}, x_{*}; \hat{θ}_{*})−c_{*}^{T}(\hat{σ}²I_{*}+C_{**})⁻¹c_{*}, (5)

where y_{*}=[yᵢ:i∈ [symbol] _{n,*} is a n_{*}x1 vector of the selected local data, c_{*}=[c(x_{i,*}, x_{*}; θ_{*}):i∈ [symbol] _{n,*} is a column vector of the covariance values between y_{*} and f(x_{*}), and C_{**}=[c(xᵢ, xⱼ; θ_{*}): i, j∈ [symbol] _{n,*} is a square matrix of the covariance values evaluated for all pairs of the selected local data. Here, \hat{σ}² and \hat{θ}_{*} represent the MLEs of σ² and θ_{*} respectively, and \hat{m}_{*} is the

MLE of m_{*}, which has the form:

$$\text{?}$$

$$\text{?} \text{indicates text missing or illegible when filed}$$

subsections which follow break down the mean μ_{J}(x_{*}) and variance s_{J}²(X_{*}) quoted in Equation (5), in terms of their contribution to bias and variance of a JGP predictor, respectively, directed toward AL application as an estimator of MSPE:

MSPE|μ_{J}(x_{*})|=Bias|μ_{J}(x_{*})|+Var|μ_{J}(x_{*})|.

With respect to bias, the JGP mean estimator \hat{m}_{*} in Equation 6 may be written as a dot product \hat{m}=αy_{*}, where the i^{th} component of α=(α₁, . . . , α_{n*}) is given as follows:

$$\text{?}$$

$$\text{?} \text{indicates text missing or illegible when filed}$$

Similarly, write μ_{J}(X_{*})=\hat{m}_{*}+β^{T}(y_{*}−\hat{m}_{*}1_{n*}) so that the j^{th} component of β=(β₁, . . . , β_{n*}) has the following form.

βⱼ=((σ²I_{n*}+C_{**})⁻¹c_{*})ⱼ

With this notation, one may write \hat{m}_{*}= [symbol] α_{i,*}y_{i,*}. Plugging into Equation (5) yields:

$$\text{?}$$

$$\text{?} \text{indicates text missing or illegible when filed}$$

using that,

$$\text{?}$$

$$\text{?} \text{indicates text missing or illegible when filed}$$

When the estimated partition [symbol] _{n,*} matches the ground truth [symbol] _{*}, quantities [symbol] [y_{i,*}]− [symbol] [f(x_{*})] and [symbol] [y_{j,*}]− [symbol] [y_{i,*}] are both are zero, so bias may be zero. When [symbol] _{n,*} disagrees with) D. , bias may be non-zero. Quantifying this bias is challenging due to difficulty of evaluating [symbol] [y_{i,*}]− [symbol] [f(x_{*})] and [symbol] [y_{j,*}]− [symbol] [y_{i,δ}]. Here we develop an upper bound of these quantities in order to obtain a useful approximation to Equation (9). Provided δ=max_{j≠k}|μⱼ−μₖ:

[symbol]

[y_{i,*}]− [symbol] [f(x_{*})]=( [symbol] [y_{i,*}|Zⱼ=1]− [symbol] [f(x_{*})|Z_{*}=0])p(Zⱼ=1)p(Z_{*}=0)+( [symbol] [y_{i,*}|Zⱼ=0]− [symbol] [f(x_{*})|Z_{*}=1])p(Zⱼ=0)p(Z_{*}=1)≤δ{p(Zⱼ=0)p(Z_{*}=1)+p(Zⱼ=1)p(Z_{*}=0)},

where Z, stands for the latent Z-variable associated with test point x_{*}. Similarly,

[symbol]

[y_{j,*}]− [symbol] [y_{i,*}]=( [symbol] [j_{i,*}|Zⱼ=1]− [symbol] [y_{i,*}|Zᵢ=1])p(Zⱼ=1)p(Zᵢ=0)+( [symbol] [j_{i,*}|Zⱼ=1]− [symbol] [y_{i,*}|Zᵢ=1])p(Zⱼ=0)p(Zᵢ=1)≤δ{p(Zᵢ=1)p(Zⱼ=0)+p(Zᵢ=0)p(Zⱼ=1)}.

Let pⱼ and p_{*} represent P(Zⱼ=1) and P(Z_{*}=1), respectively. Using the upper bounds for these two quantities, an upper bound of the bias is:

$$\text{?}$$

$$\text{?} \text{indicates text missing or illegible when filed}$$

Probabilities pⱼ and p_{*} may be estimated via Equation 4 with ω estimated by the Jump GP. Let \hat{p}ⱼ and \hat{p}_{*} denote the estimates. Inserting these into Equation (10) yields the plug-in [symbol] [x_{*}] of the upper bound,

$$\text{?} \qquad ( 11 )$$

$$\text{?} \text{indicates text missing or illegible when filed}$$

It is worth remarking that [symbol] [μ_{J}(x_{*})] in Equation (11) is influenced by accuracy of \hat{Z}, or in other words the classification accuracy of local data furnished by the CEM algorithm. The first term in [symbol] [μ_{J}(x_{*})] increases as the probability of Zⱼ≠Z_{*} increases for the selected data y_{*}, i.e, the selected data have low probabilities of being from the region of a test location. The second term in [symbol] [(x_{*})] increases as the total probabilities of the selected data y_{*} being from heterogeneous regions increase, i.e., the selected data are highly likely from heterogeneous regions.

The MSPE decomposition of Equation (7) may be completed with an estimate of predictive variance.

The variance of μ_{J}(x_{*}) also depends on Z. Conditional on Z, the variance of μ_{J}(x_{*}) is given by s_{J}²(x_{*}) in Equation (5). To make this dependency explicit, this variance may be rewritten as s_{J}²(x_{*}; Z). The law of total probability can be used to obtain can obtain the overall variance of μ_{J}(x_{*}), unconditional on Z:

$$\text{?}$$

$$\text{?} \text{indicates text missing or illegible when filed}$$

where [symbol] ⁿ represents a collection of all possible n-dimensional binary values. Evaluating expression in practice would is doable but cumbersome as the number of distinct settings of Z grows as 2^{N}. To streamline evaluation, low plausible settings may be truncated and the expression may be enumerated only for the settings with high probability values of p(Z). Given this, let [symbol] ᵣ(\hat{Z})={Z∈ [symbol] ⁿ: Zⱼ=\hat{Z}ⱼ except f or r elements}. Since

$${𝔹}^{n} = {⋃}_{r = 0}^{n} {ℬ}_{r} ( \text{?} ) , {\sum }_{r = 0}^{n} \text{?} p ( Z ) = 1 , and \qquad ( 13 )$$

$$Var [ {μ}_{J} ( {x}_{s} ) ] = \frac{{\sum }_{r = 0}^{n} \text{?} {s}_{J} ( \text{?} : Z ) p ( Z )}{{\sum }_{r = 0}^{n} \text{?} p ( Z )} ,$$

$$\text{?} \text{indicates text missing or illegible when filed}$$

where p(Z) can be estimated as \hat{p}(Z)=Πᵢ₌₁ⁿ\hat{p}ᵢ^{Z}^{ᵢ}(1−\hat{p}ᵢ)^{1-Z}^{ᵢ}. Due to the nature of the classification EM inference, the estimated value \hat{p}ᵢ is highly concentrated around 0 and 1, as is also illustrated in FIG. 2. For example, the 95 percentile of min(\hat{p}ᵢ, 1−\hat{p}ᵢ) is around 0.1, and only 5% of min(\hat{p}ᵢ, 1−\hat{p}ᵢ) is larger than 0.1, which corresponds to only one element when n=20. For Z∈ [symbol] ₁(\hat{Z}) let j denote the index of an element with Z∈ [symbol] ₁(\hat{Z}) and min(\hat{p}ᵢ, 1 −\hat{p}ᵢ) within the 95 percentile, then:

$$\hat{p} ( Z ) - \text{?} \leq \frac{0.1}{1 - 0.1} ,$$

$$because$$

$$\hat{p} ( Z ) \leq {( \frac{0.1}{1 - 0.1} )}^{r} .$$

$$\text{?} \text{indicates text missing or illegible when filed}$$

Since \hat{p}(Z) decreases exponentially as r increases, we can approximate the variance by the truncated series,

$$\text{?} \qquad ( 14 )$$

$$\text{?} \text{indicates text missing or illegible when filed}$$

The expression approaches to [symbol] [μ_{J}(x_{*})] as R→n, and may only require the evaluation

$${\sum }_{r = 0}^{R} ( \begin{matrix}n \\ r\end{matrix} ) .$$

When R=0, the approximation may be as simple as s_{J}(x_{*}; \hat{Z}). It is already a good approximation and an increase of R may get achieve marginal gains. For example, when R=0, the bias of the variance estimates for 100 test locations was -0.9819 (relative to the ground truth variance around 10), whose magnitude decreases to −0.9806 with R=1. We use R=0 for all our numerical cases.

FIG. 12 shows an empirical distribution of \hat{p}ᵢ for a test function over a two-dimensional grid of (x1, x2) illustrated in (a). The distribution shown in (b) is achieved from 20×84 sample estimates with local data size n=20 to get 20 estimates of pi per each test location for 84 test locations shown in (a).

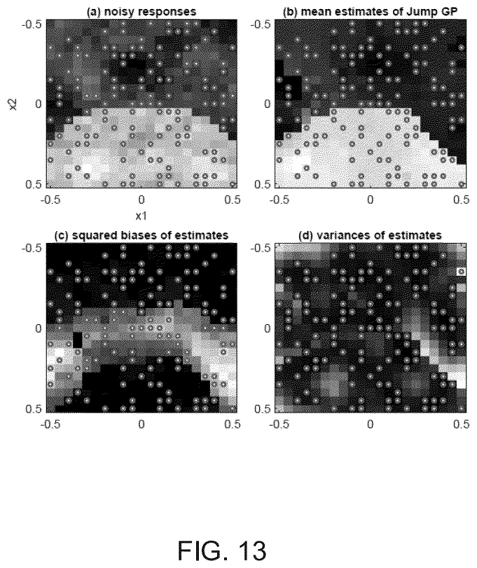

FIGS. 12 and 13 provide an illustration of how the bias and variance of JGP estimates appear. For an effective visualization, a two-dimensional rectangular domain may be used [−0.5, 0.5]², which is partitioned into two regions by a curvy boundary, as illustrated in FIG. 13. The response function for each region is randomly drawn from an independent GP with different constant mean μₖ∈{0,27} and a square exponential covariance function,

$$c ( x , {x}^{′} : {θ}_{k} ) - 9 exp \{ - \frac{1}{200} {( x , {x}^{′} )}^{𝒯} ( x , {x}^{′} ) \} .$$

an independent Gaussian noise [symbol] (0,2²) may be added on each response value.

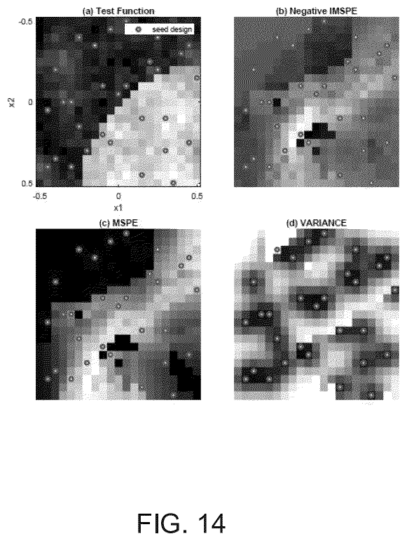

As shown in FIG. 14, 132 training inputs may be selected randomly from a uniform distribution over the domain. The noisy responses at the training inputs are used to estimate JGP. FIG. 3 (b) shows the mean estimates of Jump GP at 441 test locate over a 21×21 uniform grid of the domain. FIG. 14 also shows the calculated values of [symbol] [μ_{J}(x_{*})] and [symbol] [μ_{J}(x_{*})], respectively. High bias regions locate around the boundary of the two regions, while high variance regions locate around the domain where the training data are sparse.

With respect to AL for JGP, given training data [symbol] _{N}={(xᵢ, yᵢ), i=1, . . . , N}, AL optimizes new data collection by selecting the new data position x_{N+1} among candidate positions in [symbol] _{C}, based on a chosen AL criterion, so the training data can be augmented from [symbol] _{N} to [symbol] _{N}∪(x_{N+1}, y_{N+1}). Here we three different active learning strategies may be developed to take into account both model biases and variances of JGP.

With respect to acquisition functions, an ALM-type criterion may be considered that places x_{N+1} where the MSPE is maximized. The bias estimate provided in Equation (11) and variance estimate provided in Equation (14) may be used to define the MSPE and select x_{N+1}∈ [symbol] _{C},

$$\text{?} = \text{?} \text{?} ) , \qquad ( 15 )$$

$$( \text{?} ) = \text{?} + \text{?}$$

$$\text{?} \text{indicates text missing or illegible when filed}$$

This may be referred to as the Maximum MSPE Acquisition. An IMSPE-type criterion may also be used that sequentially selects new data points among candidate locations that improve the IMSPE most. To evaluate how the IMSPE of JGP changes with a new data (x_{N+1}, y_{N+1}), the addition affects the n-nearest neighbors of a test location x_{*} may first be determined. Let

$$R ( {X}_{*} ) = {max}_{{X}_{I ∈ {𝒟}_{n} ( {x}_{*} )}} {d}_{( {x}_{*} , {x}_{i} )}$$

denote the size of the neighborhood z,110 ₙ(x_{*}) before the new date is added, where d(⋅, ⋅) is a distance in [symbol] . When d(x_{N+1}, x_{*})≥R(x_{*}), the neighborhood does not change with the injection of the new data. Therefore, the change in IMSPE would be zero at x_{*}. Therefore, we only consider test locations x_{*} satisfying d(x_{N+1}, x_{*})<R(x_{*}). Let [symbol] (x_{N+1}) represent all test locations satisfying the condition. For x_{*}∈ [symbol] (x_{N+1}), let [symbol] ₙ(x_{*}, x_{N+1}) represent the new n-nearest neighborhood of x_{*}. Without loss generality, X_{n,*}= [symbol] ∥x_{*}−X_{i,*∥}. Then:

[symbol]

ₙ(x_{*}; x_{N+1})= [symbol] ₙ(x_{*})∪{(x_{N+1}, y_{N+1})}−{(x_{n,*}, y_{n,*})}. (16)

When (x_{N+1}, y_{N+1}) are known, one can fit JGP to [symbol] ₙ(x_{*}; x_{N+1}). Let μ_{J}(x_{*}|x_{N+1}, y_{N+1}) and s_{J}(x_{*}|x_{N+1}, y_{N+1}) denote the posterior mean and variance, based on Equation (1). The corresponding MSPE can be achieved using Equation (11) and Equation (14). The corresponding MSPE is

[symbol]

(x_{*}|x_{N+1}, y_{N+1})= [symbol] μ_{J}(x_{*}|x_{N+1}, y_{N+1})|²+ [symbol] μ_{J}(x_{*}|x_{N+1}, y_{N+1})| (17)

Since y_{N+1} is unknown, we use its posterior distribution based on the original data [symbol] ₙ(x_{*}). Specifically, we can get the predictive posterior distribution of JGP at x_{N+1} given [symbol] ₙ(x_{*}), using Equation (1). That gives by p(y_{N+1}| [symbol] ₙ(x_{*}))˜ [symbol] ₁(μ_{J})(x_{N+1}), S_{J}(x_{N+1})). The IMSPE is defined as the average MSPE over x_{*} and yₙ₊₁,

I [symbol] E(x_{N+1})=∫∫ [symbol] (x_{*}|x_{N+1}, y_{N+1})p(y_{N+1}| [symbol] ₙ(x_{*}))dx_{*}dy_{N+1}. (18)

We can use the Monte Carlo simulation to evaluate the integration. We can select x_{N+1} that minimizes I [symbol] E(x_{N+1}). This AL is referred to as the Minimum IMSPE Acquisition. For a simple benchmark, we can also consider the Maximum Variance Acquisition that selects xN+1

$${x}_{N + 1} = \text{?} \text{?} \qquad ( 19 )$$

$$\text{?} \text{indicates text missing or illegible when filed}$$

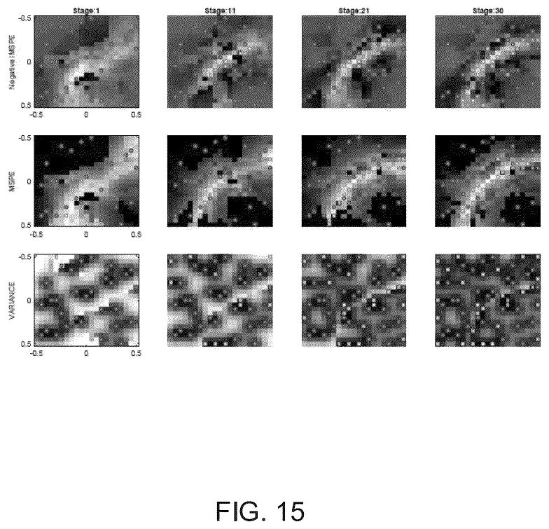

FIGS. 14 and 15 illustrate a visualization of the three acquisition functions described previously. For effective visualization, a two-dimensional rectangular domain may be used [0, 2]\hat{ }2. The domain may be partitioned into two region, [symbol] ₁ (lighter region) and [symbol] ₁ (darker region), as illustrated in FIG. 14, and the noisy response function for each region may be randomly drawn from an independent GP with the same regional means and covariance functions described herein. Its noisy observation may be generated by adding a white Gaussian noise with σ=2. 30 seed data positions may be selected using LHD, as illustrated in FIG. 14, however, this is not intended to be limiting. Given the noisy observations at the seed positions, the three criteria may be evaluated at 21*21 grid positions over the domain. FIG. 14 visualizes the values. The maximum variance criterion shown in FIG. 15 shows the values of [symbol] [μ_{J}(x_{*})].

As shown in FIG. 14, the values may be inversely proportional to the densities of seed data, working similarly as the conventional variance-based criteria (such as ALM or ALC) for stationary GPs. One slight difference from the conventional variance-criteria may be that the variance of Jump GP is slightly higher around regional boundaries. Around the boundaries, local data may be bisected, and only one section may be used to make a prediction of Jump GP, which makes the variance elevated around the boundaries.

FIG. 15 illustrates that slightly more data positions are selected around regional boundaries with the variance criterion. As shown in Figures FIG. 15, the negative IMSPE and MSPE values are high around regional boundaries, mainly due to high biases around the boundary regions. The selections of the future data positions differ according to the acquisition functions. For the same toy example, active learning may be performed for each choice of the three acquisition functions: start with a seed design of 30 data every active learning stage for 30 stages.

FIG. 15 also shows how the acquisition function values change as the AL stage progresses and how they affect the selection of data positions. For the IMSPE and MSPE criteria, the selected positions are highly concentrated around regional boundaries. With the variance criterion, the positions are close to a uniform distribution with a mild degree of concentration around the regional boundary.

The choices of the data positions may impact the prediction accuracy of JGP. Here, 20 replicated experiments of active learning with the same test function but different random samples may be performed. We report the mean squared error statistics of JGP. We give two MSE values for two test datasets. The first set consists of 441 test data locating over a 21*21 grid of the domain of the test function, and the second set only contains 82 closet to the regional boundary. FIGS. 6A-6C report the overall MSE with the first set, and FIGS. 6D-6F report the MSE near the regional boundary. The overall MSE values are significantly different in early AL stages (before stage 21), and the gaps saturate in the later stages as data points become denser. Using the minimum IMSPE criterion achieves the best overall MSE for all stages. The maximum MSPE criterion is the most effective in reducing the MSE near the regional boundary. This suggests using the IMSPE criterion for estimating an entire response surface but use the MSPE criterion when the boundary prediction is concerned. When the computation speed for active learning is concerned, using MSPE is more suggested, because evaluating IMSPE is much more expensive in computation (e.g. 0.12 seconds versus 0.07 seconds) for this toy example).

Embodiments of the subject invention provide a focused technical solution to the focused technical problem of how to generate an image of a sample without increasing probing time or risk of damaging the sample (e.g., due to increased exposure to the probes). The solution is provided by a machine learning algorithm to reconstruct an image of the sample via adaptive probing of a piecewise continuous surface. The systems and methods of embodiments of the subject invention allow for image reconstruction without increasing the probing time or the risk of damaging the sample. Embodiments of the subject invention can improve the computer system performing the steps of the machine learning algorithm by using the adaptive probing of the piecewise continuous surface, thereby converging on a reconstructed image more quickly (freeing up memory and/or processor usage).

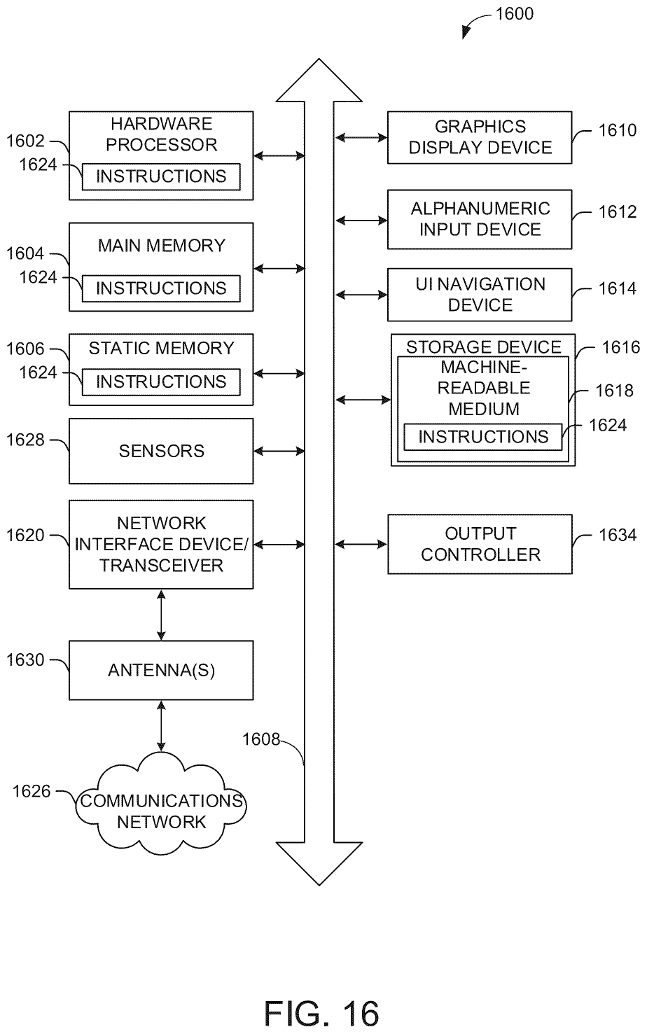

FIG. 16 depicts a block diagram of an example machine 1600 upon which any of one or more techniques (e.g., methods) may be performed, in accordance with one or more example embodiments of the present disclosure. In other embodiments, the machine 1600 may operate as a standalone device or may be connected (e.g., networked) to other machines. In a networked deployment, the machine 1600 may operate in the capacity of a server machine, a client machine, or both in server-client network environments. In an example, the machine 1600 may act as a peer machine in peer-to-peer (P2P) (or other distributed) network environments. The machine 1600 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

The machine (e.g., computer system) 1600 may include a hardware processor 1602 (e.g., a central processing unit (CPU), a graphics processing unit (GPU), a hardware processor core, or any combination thereof), a main memory 1604 and a static memory 1606, some or all of which may communicate with each other via an interlink (e.g., bus) 1608. The machine 1600 may further include a graphics display device 1610, an alphanumeric input device 1612 (e.g., a keyboard), and a user interface (UI) navigation device 1614 (e.g., a mouse). In an example, the graphics display device 1610, alphanumeric input device 1612, and UI navigation device 1614 may be a touch screen display. The machine 1600 may additionally include a storage device (i.e., drive unit) 1616, a network interface device/transceiver 1620 coupled to antenna(s) 1630, and one or more sensors 1628, such as a global positioning system (GPS) sensor, a compass, an accelerometer, or other sensor. The machine 1600 may include an output controller 1634, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)).

The storage device 1616 may include a machine readable medium 1622 on which is stored one or more sets of data structures or instructions 1624 (e.g., software) embodying or utilized by any one or more of the techniques or functions described herein. The instructions 1624 may also reside, completely or at least partially, within the main memory 1604, within the static memory 1606, or within the hardware processor 1602 during execution thereof by the machine 1600. In an example, one or any combination of the hardware processor 1602, the main memory 1604, the static memory 1606, or the storage device 1616 may constitute machine-readable media.

While the machine-readable medium 1622 is illustrated as a single medium, the term “machine-readable medium” may include a single medium or multiple media (e.g., a centralized or distributed database, and/or associated caches and servers) configured to store the one or more instructions 1624.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 1600 and that cause the machine 1600 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD- ROM disks.

The instructions 1624 may further be transmitted or received over a communications network 1626 using a transmission medium via the network interface device/transceiver 1620 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 1620 may include one or more physical jacks (e.g., Ethernet, coaxial, or phone jacks) or one or more antennas to connect to the communications network 1626. In an example, the network interface device/transceiver 1620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 1600 and includes digital or analog communications signals or other intangible media to facilitate communication of such software. The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

Further, in the present specification and annexed drawings, terms such as “store,” “storage,” “data store,” “data storage,” “memory,” “repository,” and substantially any other information storage component relevant to the operation and functionality of a component of the disclosure, refer to memory components, entities embodied in one or several memory devices, or components forming a memory device. It is noted that the memory components or memory devices described herein embody or include non-transitory computer storage media that can be readable or otherwise accessible by a computing device. Such media can be implemented in any methods or technology for storage of information, such as machine-accessible instructions (e.g., computer-readable instructions), information structures, program modules, or other information objects.

What has been described herein in the present specification and annexed drawings includes examples of systems, devices, techniques, and computer program products that, individually and in combination, certain systems and methods. It is, of course, not possible to describe every conceivable combination of components and/or methods for purposes of describing the various elements of the disclosure, but it can be recognized that many further combinations and permutations of the disclosed elements are possible. Accordingly, it may be apparent that various modifications can be made to the disclosure without departing from the scope or spirit thereof. In addition, or as an alternative, other embodiments of the disclosure may be apparent from consideration of the specification and annexed drawings, and practice of the disclosure as presented herein. It is intended that the examples put forth in the specification and annexed drawings be considered, in all respects, as illustrative and not limiting. Although specific terms are employed herein, they are used in a generic and descriptive sense only and not for purposes of limitation.

The methods and processes described herein can be embodied as code and/or data. The software code and data described herein can be stored on one or more machine-readable media (e.g., computer-readable media), which may include any device or medium that can store code and/or data for use by a computer system. When a computer system and/or processor reads and executes the code and/or data stored on a computer-readable medium, the computer system and/or processor performs the methods and processes embodied as data structures and code stored within the computer-readable storage medium.

It should be appreciated by those skilled in the art that computer-readable media include removable and non-removable structures/devices that can be used for storage of information, such as computer-readable instructions, data structures, program modules, and other data used by a computing system/environment. A computer-readable medium includes, but is not limited to, volatile memory such as random access memories (RAM, DRAM, SRAM); and non-volatile memory such as flash memory, various read-only-memories (ROM, PROM, EPROM, EEPROM), magnetic and ferromagnetic/ferroelectric memories (MRAM, FeRAM), and magnetic and optical storage devices (hard drives, magnetic tape, CDs, DVDs); network devices; or other media now known or later developed that are capable of storing computer-readable information/data. Computer-readable media should not be construed or interpreted to include any propagating signals. A computer-readable medium of embodiments of the subject invention can be, for example, a compact disc (CD), digital video disc (DVD), flash memory device, volatile memory, or a hard disk drive (HDD), such as an external HDD or the HDD of a computing device, though embodiments are not limited thereto. A computing device can be, for example, a laptop computer, desktop computer, server, cell phone, or tablet, though embodiments are not limited thereto.

When ranges are used herein, combinations and subcombinations of ranges (e.g., subranges within the disclosed range), as well as specific embodiments therein, are intended to be explicitly included. When the term “about” is used herein, in conjunction with a numerical value, it is understood that the value can be in a range of 95% of the value to 105% of the value, i.e. the value can be +/−5% of the stated value. For example, “about 1 kg” means from 0.95 kg to 1.05 kg.

It should be understood that the examples and embodiments described herein are for illustrative purposes only and that various modifications or changes in light thereof will be suggested to persons skilled in the art and are to be included within the spirit and purview of this application.

All patents, patent applications, provisional applications, and publications referred to or cited herein are incorporated by reference in their entirety, including all figures and tables, to the extent they are not inconsistent with the explicit teachings of this specification.

What is claimed is:

1. A system for reconstructing an image of a sample, the system comprising:
a processor; and
a machine-readable medium in operable communication with the processor and having instructions thereon that, when executed, perform the following steps:
receiving first data corresponding to a plurality of probe points of the sample;
generating a first estimate of a piecewise continuous surface based on the first data; and
using a machine learning algorithm to perform adaptive probing on the piecewise continuous surface to obtain a reconstructed image of the sample.

2. The system according to claim 1, wherein the using of the machine learning algorithm to perform adaptive probing on the piecewise continuous surface comprises:
i) identifying, by the machine learning algorithm based on the first estimate of the piecewise continuous surface, an updated plurality of probe points of the sample;
ii) receiving, by the machine learning algorithm, updated data corresponding to the updated plurality of probe points of the sample;
iii) generating, by the machine learning algorithm, an updated estimate of the piecewise continuous surface based on the updated data;
iv) identifying, by the machine learning algorithm based on the updated estimate of the piecewise continuous surface, an updated plurality of probe points of the sample; and
v) repeating substeps ii)-iv) at least once.

3. The system according to claim 2, wherein substep v) comprises iteratively repeating substeps ii)-iv) until the updated data is sufficient data to generate an accurate reconstructed image.

4. The system according to claim 2, wherein substep v) comprises iteratively repeating substeps ii)-iv) a predetermined number of times, wherein the predetermined number of times is at least two.

5. The system according to claim 2, wherein in substeps i) and iv), the updated plurality of probe points of the sample are identified based on bias and variance.

6. The system according to claim 2, wherein in substeps i) and iv), the updated plurality of probe points of the sample are identified using a jump Gaussian process (JGP).

7. The system according to claim 6, wherein the JGP uses mean square error (MSE).

8. The system according to claim 6, wherein the JGP uses mean square prediction error (MSPE).

9. The system according to claim 1, wherein the instructions when executed further perform the step of training the machine learning algorithm before receiving the first data.

10. The system according to claim 1, further comprising a display in operable communication with the processor, wherein the instructions when executed further perform the step of displaying the reconstructed image of the sample on the display.

11. A method for reconstructing an image of a sample, the method comprising:
receiving first data corresponding to a plurality of probe points of the sample;
generating a first estimate of a piecewise continuous surface based on the first data; and
using a machine learning algorithm to perform adaptive probing on the piecewise continuous surface to obtain a reconstructed image of the sample.

12. The method according to claim 11, wherein the using of the machine learning algorithm to perform adaptive probing on the piecewise continuous surface comprises:
i) identifying, by the machine learning algorithm based on the first estimate of the piecewise continuous surface, an updated plurality of probe points of the sample;
ii) receiving, by the machine learning algorithm, updated data corresponding to the updated plurality of probe points of the sample;
iii) generating, by the machine learning algorithm, an updated estimate of the piecewise continuous surface based on the updated data;
iv) identifying, by the machine learning algorithm based on the updated estimate of the piecewise continuous surface, an updated plurality of probe points of the sample; and
v) repeating substeps ii)-iv) at least once.

13. The method according to claim 12, wherein substep v) comprises iteratively repeating substeps ii)-iv) until the updated data is sufficient data to generate an accurate reconstructed image.

14. The method according to claim 12, wherein substep v) comprises iteratively repeating substeps ii)-iv) a predetermined number of times, wherein the predetermined number of times is at least two.

15. The method according to claim 12, wherein in substeps i) and iv), the updated plurality of probe points of the sample are identified based on bias and variance.

16. The method according to claim 11, wherein in substeps i) and iv), the updated plurality of probe points of the sample are identified using a jump Gaussian process (JGP).

17. The method according to claim 16, wherein the JGP uses mean square prediction error (MSPE).

18. The method according to claim 11, further comprising training the machine learning algorithm before receiving the first data.

19. The method according to claim 11, further displaying the reconstructed image of the sample on a display.

20. A system for reconstructing an image of a sample, the system comprising:
a processor;
a display in operable communication with the processor; and
a machine-readable medium in operable communication with the processor and the display and having instructions thereon that, when executed, perform the following steps:
receiving first data corresponding to a plurality of probe points of the sample;
generating a first estimate of a piecewise continuous surface based on the first data;
using a machine learning algorithm to perform adaptive probing on the piecewise continuous surface to obtain a reconstructed image of the sample; and
displaying the reconstructed image of the sample on the display,
wherein the using of the machine learning algorithm to perform adaptive probing on the piecewise continuous surface comprises:
i) identifying, by the machine learning algorithm based on the first estimate of the piecewise continuous surface, an updated plurality of probe points of the sample;
ii) receiving, by the machine learning algorithm, updated data corresponding to the updated plurality of probe points of the sample;
iii) generating, by the machine learning algorithm, an updated estimate of the piecewise continuous surface based on the updated data;
iv) identifying, by the machine learning algorithm based on the updated estimate of the piecewise continuous surface, an updated plurality of probe points of the sample; and
v) iteratively repeating substeps ii)-iv) until the updated data is sufficient data to generate an accurate reconstructed image,
wherein in substeps i) and iv), the updated plurality of probe points of the sample are identified using a jump Gaussian process (JGP), and
wherein the JGP uses mean square prediction error (MSPE).
